(19) United States
(12) Patent Application Publication
(10) Pub. No.: US 2004/0153431 A1
(43) Pub. Date: Aug. 5, 2004

(54) Method and apparatus for protecting e-mail messages

(75) Inventors: Kulvir Singh Bhogal, Fort Worth, TX (US); Nizamudeen Ishmael, JR., Austin, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY (US)

(21) Appl. No.: 10/355,687

(22) Filed: Jan. 30, 2003

(51) Int. Cl. G06F 7/00

(52) U.S. Cl. 707/1

(57) ABSTRACT

A method, apparatus, and computer instructions for managing a plurality of received e-mail messages. A set of e-mail messages from specified senders in the plurality of received e-mail messages is identified in which the set of e-mail messages are to be protected from deletion and form a set of protected e-mail messages. An indication is provided in response to a selection of a protected e-mail message from a set of protected e-mail messages, wherein the indication indicates that the e-mail message is protected. Deletion of the protected e-mail message is prohibited unless a further user input is received in response to the selection of the protected e-mail message.

### BACKGROUND OF THE INVENTION

1. Technical Field

The present invention relates generally to an improved data processing system, and in particular, to a method and apparatus for processing e-mail messages. Still more particularly, the present invention provides a method and apparatus for protecting selected e-mail messages from deletion.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the Transmission Control Protocol/Internet Protocol (TCP/IP) suite of protocols.

The Internet has become a cultural fixture as a source of information, entertainment, and communications. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies that must interact with virtually all segments of society such as the Internal Revenue Service and secretaries of state. Further, the Internet is a popular medium for commercial transactions.

In addition to being a source of information, the Internet also provides a communications medium. The Internet has become the most popular computer network used by consumers and businesses to send and receive electronic mail, also referred to as “e-mail”. The Internet allows users to readily send and receive e-mail to and from computers around the world. Each user typically has a unique Internet e-mail address (e.g., steve@ibm.com). A user with an e-mail account and a computer capable of connecting to the Internet can easily send and receive e-mail over the network.

E-mail allows a person to quickly and easily send textual messages and other information, such as, for example, pictures, sound recordings, and formatted documents electronically to other e-mail users anywhere in the world. An e-mail user will typically create a message using an e-mail program running on a computer connected to a computer network through a modem or network card. The message will include an e-mail “address” for the intended recipient. When the user has finished entering the message, the user may “send” the message to the intended recipient. The e-mail program then electronically transmits the message over the computer network. The recipient, using an e-mail program running on the recipient's computer, can then “receive” the message.

In dealing with e-mail messages, many users are inundated with numerous messages on a daily basis. Some e-mail messages have a higher level of importance than others. For example, an unsolicited e-mail message about travel offers is less important than an e-mail message from a supervisor about new procedures or an e-mail message confirming an order. With important e-mail messages, such as new procedures or order confirmations, it is often essential that those types of messages not be deleted. In going through e-mail messages, a user may often delete messages that appear to be unimportant. In wading through numerous messages, the user sometimes may delete an important message. If the user sees the error, the user may retrieve the message from the deleted or trash folder. In some cases, the user never knows that an important message has been deleted.

Therefore, it would be advantageous to have an improved method, apparatus, and computer instructions for protecting e-mail messages from deletion.

### SUMMARY OF THE INVENTION

The present invention provides a method, apparatus, and computer instructions for managing a plurality of received e-mail messages. A set of e-mail messages from specified senders in the plurality of received e-mail messages is identified in which the set of e-mail messages are to be protected from deletion and form a set of protected e-mail messages. An indication is provided in response to a selection of a protected e-mail message from a set of protected e-mail messages, wherein the indication indicates that the e-mail message is protected. Deletion of the protected e-mail message is prohibited unless a further user input is received in response to the selection of the protected e-mail message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram illustrating a data processing system in which the present invention may be implemented;

FIG. 3 is a block diagram of a messaging system in which a message handling process of the present invention may be used in accordance with a preferred embodiment of the present invention;

FIG. 4 is a block diagram of components used in processing messages in accordance with a preferred embodiment of the present invention;

FIGS. 5A and 5B are diagrams illustrating an e-mail message protection system in accordance with a preferred embodiment of the present invention;

FIG. 6 is a flowchart of a process used for processing e-mail messages in accordance with a preferred embodiment of the present invention;

FIG. 7 is a flowchart of a process used for processing stored e-mail messages that have been marked as protected in accordance with a preferred embodiment of the present invention; and

FIG. 8 is a flowchart of a process used for processing a user input requesting deletion of an e-mail message in accordance with a preferred embodiment of the present invention.

### DETAILED DESCRIPTION OF THE PREFERRED EMBODIMENT

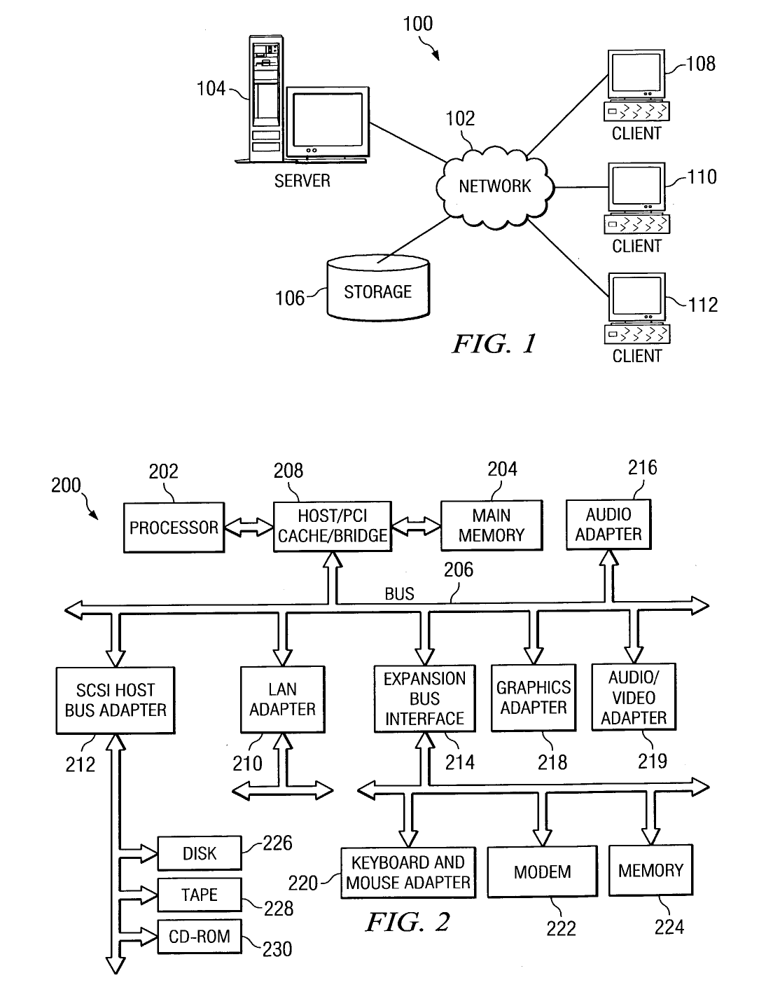

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. In the depicted example, server 104 is connected to network 102 along with storage unit 106. In addition, clients 108, 110, and 112 also are connected to network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. In the depicted examples, server 104 may contain an electronic mail system from which clients 108, 110, and 112 send and receive e-mail messages.

Distributed data processing system 100 may include additional servers, clients, and other devices not shown. For example, messages may be sent and received between server 104 and other servers (not shown) to distribute and receive messages from other clients (not shown). Of course, distributed data processing system 100 may include other types of clients other than a computer. Other types of clients which may receive and exchange e-mail messages include, for example without limitation, a PDA, a digital phone, a game console, a digital video recorder, and an electronic book device.

In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

Turning now to FIG. 2, a block diagram illustrating a data processing system is shown in which the present invention may be implemented. Data processing system 200 is an example of a client computer. Data processing system 200 employs a peripheral component interconnect (PCI) local bus architecture. Although the depicted example employs a PCI bus, other bus architectures such as Micro Channel and ISA may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230.

An operating system runs on processor 202 and is used to coordinate and provide control of various components within data processing system 200 in FIG. 2. The operating system may be a commercially available operating system such as OS/2, which is available from International Business Machines Corporation. “OS/2” is a trademark of International Business Machines Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM drive 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be any device featuring some kind of browser and capable of receiving e-mail messages, such as a PDA, a digital phone, digital/satellite TVs, wireless devices, set-top boxes, MP3 players, wearable devices such as wrist watches, e-books, pagers, and game consoles.

The depicted example in FIG. 2 and above-described examples are not meant to imply architectural limitations.

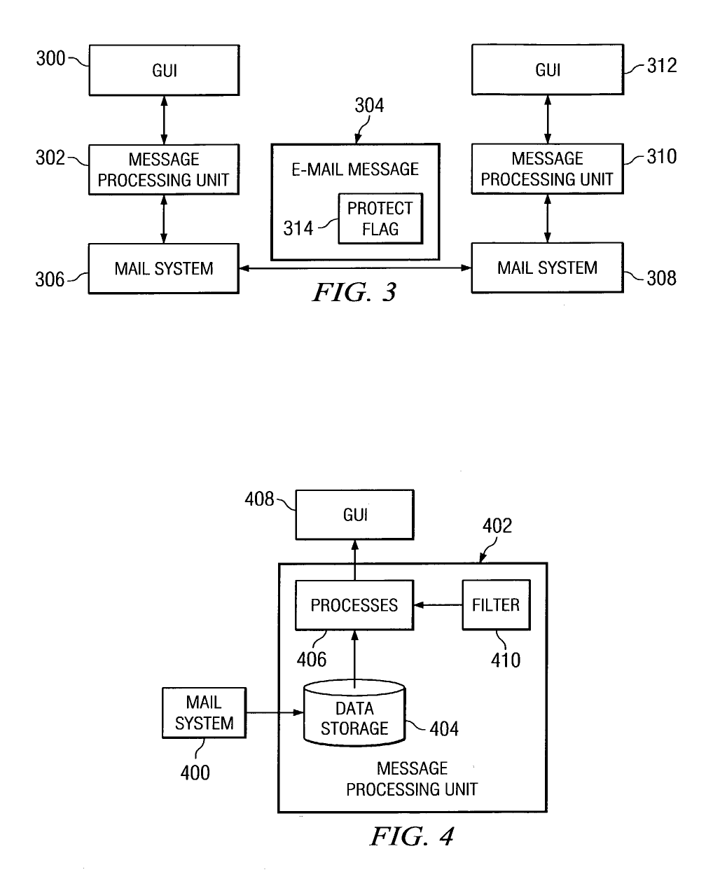

With reference now to FIG. 3, a block diagram of a messaging system in which a message handling process of the present invention may be used is depicted in accordance with a preferred embodiment of the present invention. In this example, a graphical user interface (GUI) 300 is used in combination with a message processing unit 302 to send an electronic message, such as e-mail message 304. In this example, e-mail message 304 is an e-mail message that is sent through mail system 306 to mail system 308 for receipt by message processing unit 310, which selectively provides a display of the message in a message list within GUI 312. In this example, GUI 300, message processing unit 302, and mail system 306 may be located at one client while GUI 312, message processing unit 310, and mail system 308 are located at another client in a distributed data processing system. In these examples, mail system 306 and mail system 308 are legacy mail systems while GUI 300, message processing unit 302, GUI 312, and message processing unit 310 implement processes of the present invention. These clients may be implemented using a data processing system, such as data processing system 200 in FIG. 2.

The present invention provides an improved method, apparatus, and computer instructions for protecting e-mail messages received at message processing units 302 and 310 from being deleted. The mechanism of the present invention allows a user to mark or identify senders or e-mail addresses as being trusted. In this manner, when an e-mail message is received from one of these trusted senders, accidental deletion of the e-mail message is prevented. For example, if a supervisor sends an employee an e-mail message and the employee accidentally tries to delete the e-mail message, the employee is provided with a prompt identifying the message as one that is protected. The mechanism of the present invention prevents deletion of this e-mail message without user input, such as a confirmation of the deletion.

A sender may identify an e-mail message as being protected through some flag or other indicator in the e-mail message. In this example, protect flag 314 is placed into the header of e-mail message 304. Thus, an e-mail message is protected in this example when a protect flag is present and when the sender has been identified or marked as trusted. Further, a sender may be identified as trusted even if not designated as trusted. For example, trusted parties may be pre-designated from a user's chain of command in a company. Thus, when an e-mail message is received with a protect flag, the message processing unit may check a database or other data structure to determine whether the e-mail message should be protected. Protection may be such that the e-mail message may not be deleted even with a confirmation by the user. The protection may extend for some selected period of time.

Message processing unit 302 and message processing unit 310 process e-mail messages created and received by the user through presently available or legacy mail system processes found in mail system 306 and mail system 308. The legacy mail systems may be implemented using currently available mail systems, such as Lotus Notes or CC Mail, which are available from Lotus Development Corporation. Other mail systems, which may be used, include, for example, Microsoft Outlook and Yahoo Mail Client. Microsoft Outlook is available from Microsoft Corporation and Yahoo Mail Client is available from Yahoo! Inc.

The actual storage and transmission of e-mail messages, including customized content, is implemented using conventional e-mail data formats and protocols. The separation of these functions is shown for purposes of clearly illustrating the present invention. Of course, depending on the implementation, the processes of the present invention may be implemented directly within a mail system.

Turning now to FIG. 4, a block diagram of components used in processing messages is depicted in accordance with a preferred embodiment of the present invention. In this example, mail system 400 receives messages. Message processing unit 402 periodically retrieves e-mail messages from mail system 400 for storage within data storage 404. Specifically, processes 406 parse and examine an e-mail message received from mail system 400 to determine whether e-mail messages received from mail system 400 should be protected from deletion.

In this example, filter 410 is employed to identify whether any of the received e-mail messages contain an indication, such as a flag, that the e-mail message should be protected. If such an indication is present, filter 410 is also used by processes 406 to determine whether the e-mail message originates from a trusted sender. The trusted sender may be one designated by the user. Alternatively, the trusted sender may be one pre-designated. For example, senders up a chain of command in a company may be pre-designated as trusted senders. In another example, selected sponsors of an Internet provider may be designated as trusted. After all of the e-mail messages or as the e-mail messages are processed, these e-mail messages are presented in an inbox in GUI 408.

If a user tries to delete a protected e-mail message, a prompt is provided to the user to indicate that the e-mail message is protected. At that time, an additional user input may be used to delete the e-mail message. In this manner, an e-mail message may be protected from accidental deletion. In other implementations, some trusted senders may be set up such that deletion of an e-mail message cannot occur until some period of time has passed. In this instance, even a confirmation of a deletion will not delete the e-mail message.

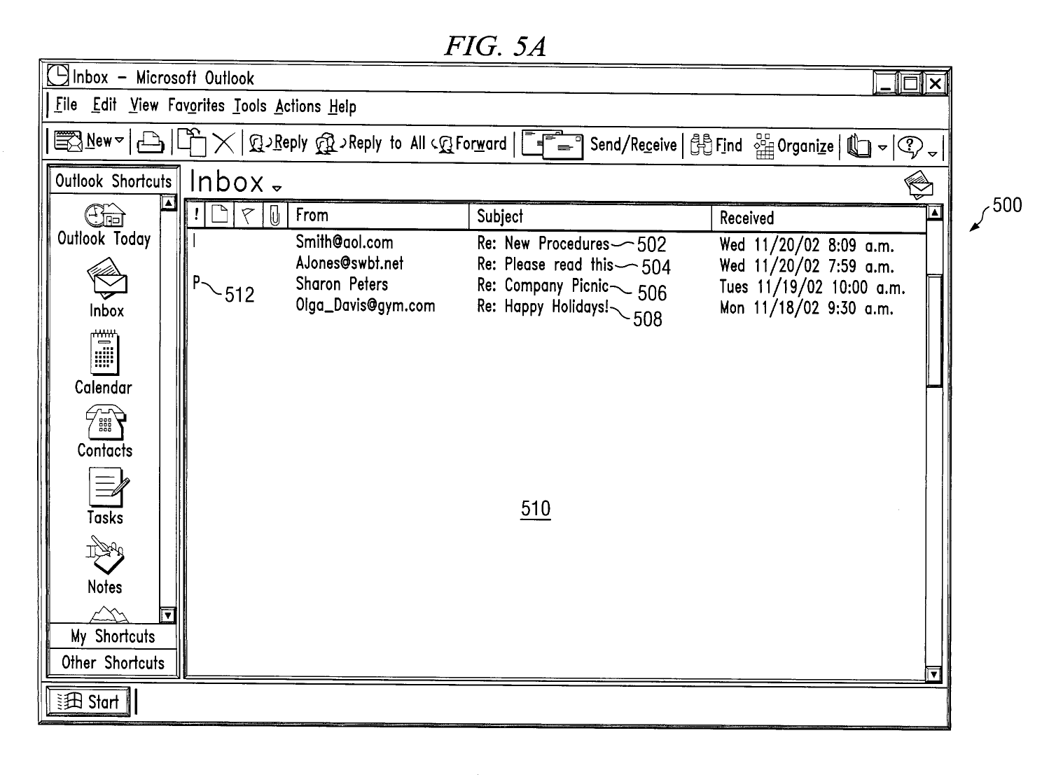

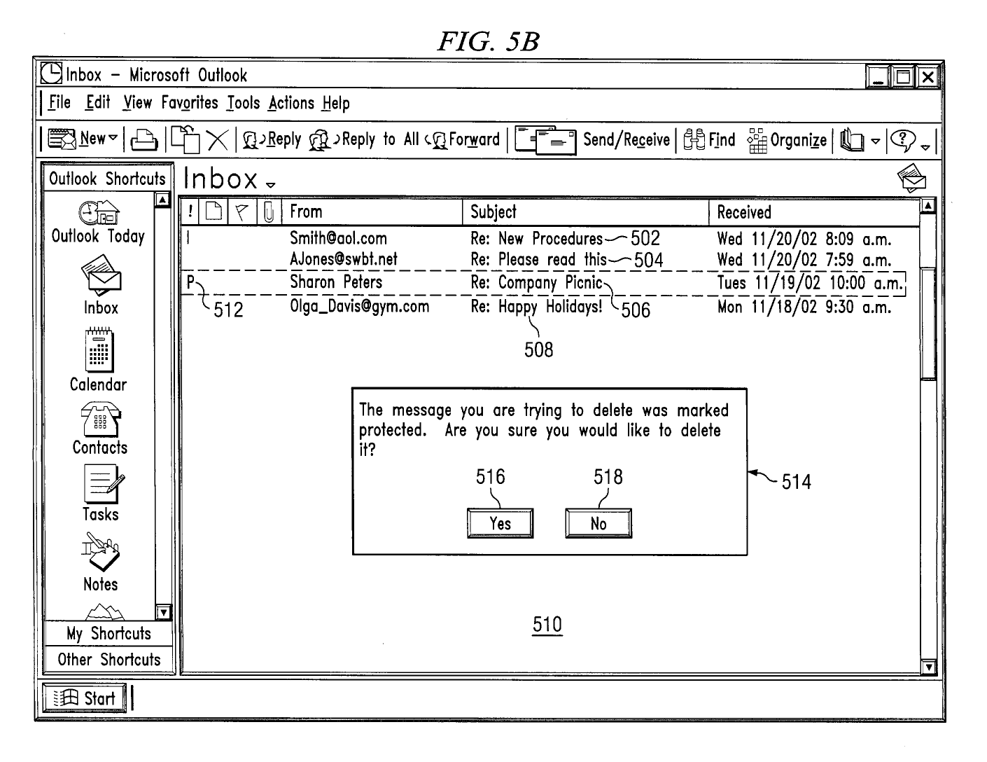

With reference now to FIGS. 5A and 5B, diagrams illustrating an e-mail message protection system are depicted in accordance with a preferred embodiment of the present invention. In this example, window 500 in FIG. 5A is presented in a GUI for an e-mail system. Window 500 may be implemented as part of GUI 408 in FIG. 4. E-mail messages 502, 504, 506, and 508 are displayed in inbox 510. In this example, graphical indicator 512 identifies e-mail message 506 as being a protected e-mail message. The other e-mail messages, e-mail messages 502, 504, and 508 are unprotected. Graphical indicator 512 is optional and may not be used depending on the particular implementation.

In FIG. 5B, e-mail message 506 has been selected by the user for deletion. In response to this attempted deletion, prompt 514 is presented to the user. Prompt 514 takes the form of a pop-up message in this example. The message states: “The message you are trying to delete was marked protected by the sender. Are you sure you would like to delete it?” The user may confirm deletion by selecting yes button 516. If the user does not wish to confirm deletion, the user may select no button 518. In this manner, the mechanism of the present invention prevents accidental deletion of e-mail messages by a user. The form of prompt 514 as a pop-up window is provided for purposes of illustration and is not intended to limit the manner in which the prompt is presented. For example, the prompt may be an audible one using a text-to-speech conversion to present the warning message about the attempted deletion.

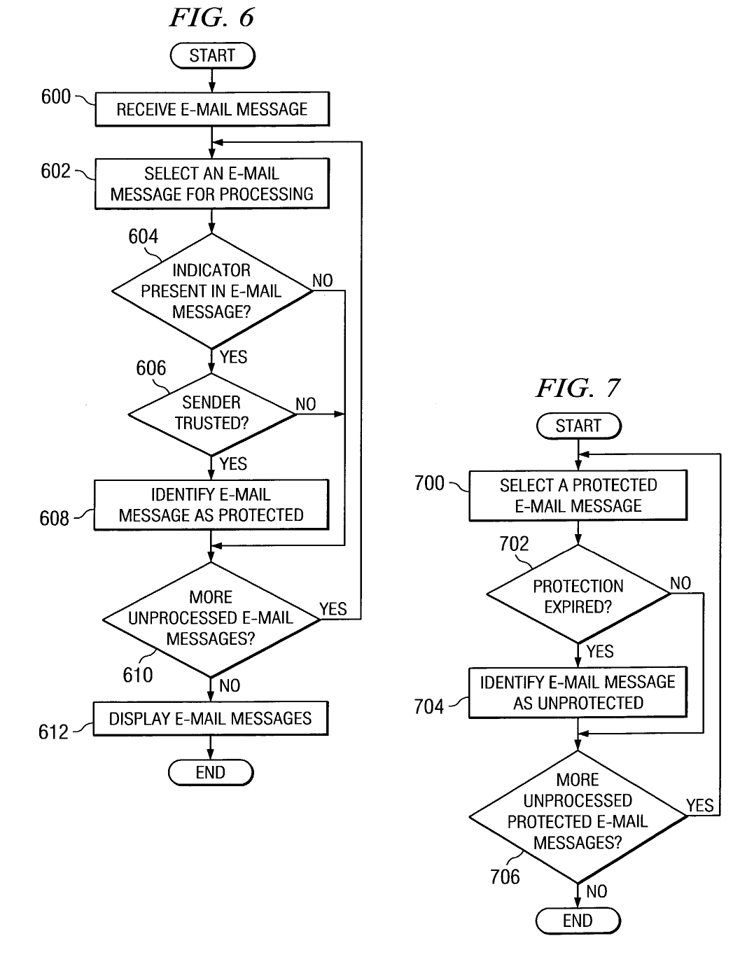

With reference now to FIG. 6, a flowchart of a process used for processing e-mail messages is depicted in accordance with a preferred embodiment of the present invention. The process illustrated in FIG. 6 may be implemented in a message processing unit, such as message processing unit 402 in FIG. 4.

The process begins by receiving an e-mail message (step 600). An e-mail message is selected for processing (step 602). A determination is made as to whether an indicator is present in the e-mail message (step 604). The e-mail message may be marked using different flags for different situations in which each flag identifies how the e-mail message would be protected. For example, one type of flag (PC) may be used to protect the e-mail message but allowing it to be deleted with a confirmation. A different flag (PN) may be used to protect an e-mail message that can never be deleted, while a third flag (PC20) may allow for deletion of the e-mail message after twenty days from receipt. Of course, the type of flag would depend on the particular implementation.

If an indicator is present in the e-mail message, a determination is made as to whether the sender is trusted (step 606). If the sender is trusted, the e-mail message is identified as protected (step 608). Next, a determination is made as to whether more unprocessed e-mail messages are present (step 610). If more unprocessed e-mail messages are absent, the e-mail messages are displayed (step 612) with the process terminating thereafter.

Returning again to step 610, if more unprocessed e-mail messages are present, the process returns to step 602 as described above. With reference again to step 606, if the sender is not trusted, the process proceeds to step 610 as described above. Referring again to step 604, if an indicator is not present in the e-mail message, the process proceeds to step 610 as described above.

Turning now to FIG. 7, a flowchart of a process used for processing stored e-mail messages that have been marked as protected is depicted in accordance with a preferred embodiment of the present invention. The process illustrated in FIG. 7 may be implemented in a message processing unit, such as message processing unit 402 in FIG. 4.

The process begins by selecting a protected e-mail message (step 700). A determination is made as to whether the protection has expired (step 702). If the protection has expired, the e-mail message is identified as unprotected (step 704). A determination is made as to whether more unprocessed protected e-mail messages are present (step 706). If there are no more unprocessed protected e-mail messages present, the process terminates.

Referring again to step 706, it more unprocessed protected e-mail messages are present, the process returns to step 700 as described above. With reference again to step 702, if the protection has expired, the process proceeds to step 706 as described above.

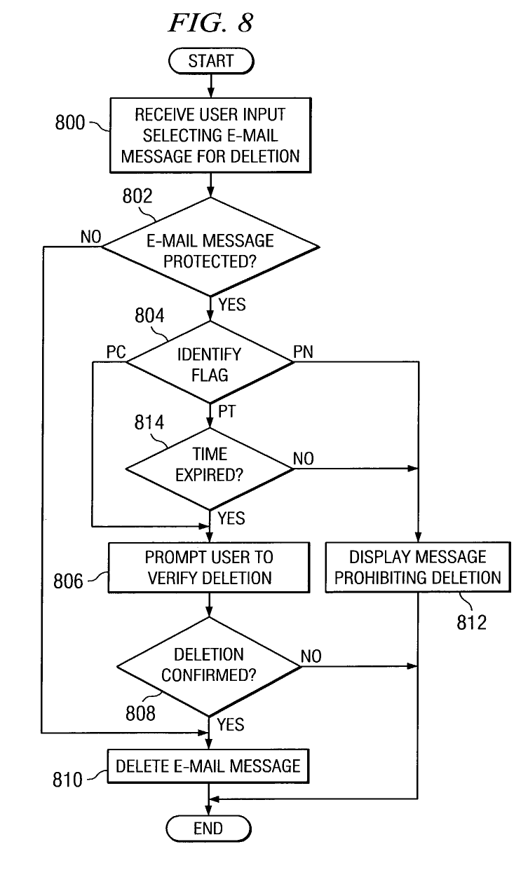

With reference now to FIG. 8, a flowchart of a process used for processing a user input requesting deletion of an e-mail message is depicted in accordance with a preferred embodiment of the present invention. The process illustrated in FIG. 8 may be implemented in a message processing unit, such as message processing unit 402 in FIG. 4.

The process begins by receiving user input selecting an e-mail message for deletion (step 800). A determination is made as to whether the e-mail message is protected (step 802). If the e-mail message is protected, an identification of the flag in the e-mail message is made (step 804). If the flag is a PC flag, a conditional deletion is possible and the user is prompted to verify deletion (step 806). This prompt may take the form of prompt 514 illustrated in FIG. 5B.

Next, a determination is made as to whether the deletion has been confirmed (step 808). If the deletion has been confirmed, the e-mail message is deleted (step 810) and the process terminates thereafter. With reference again to step 808, if the deletion is not confirmed, the process terminates.

Turning again to step 804, if the flag is a PN flag, the message may not be deleted and a message stating that deletion of the e-mail message is prohibited is displayed (step 812) and the process terminates thereafter. This message may state, for example, “You have attempted to delete an important message from the sender that cannot be deleted.”

Turning again to step 804, if the flag is identified as protecting the e-mail message from deletion for a selected period of time, such as a PT flag, then a determination is made as to whether the time period has expired (step 814). If the time period has not expired, the process proceeds to step 812 to display a message prohibiting deletion of the message. This message may state: “You have attempted to delete an important message from the sender that cannot be deleted for 20 days from date of receipt”. On the other hand, if the time has expired, the process proceeds to step 806 as described above. With reference again to step 802, if the e-mail message is not protected, the process proceeds to step 810 as described above.

The example process illustrated in FIG. 8 describes the handling of three types of flags. One flag, PC, in which the message may be deleted after a confirmation, another flag, PN, in which the message may not be deleted at all, and a third flag, PT, that protects the e-mail message from deletion for a selected period of time. Of course, other types of flags may be handled through a similar type of process.

Further, the mechanism of the present invention also may be applied to allow a user to protect messages on the user end. In such an implementation, the user may add flags to messages just as sender would. These flags may be added through the e-mail program using a window, such as window 500 in which the user may select an e-mail message for protection, resulting in a graphical indicator, such a graphical indicator 512 being displayed in association with a particular e-mail message.

Thus, the present invention provides an improved method, apparatus, and computer instructions for protecting e-mail messages from deletion. The mechanism of the present invention identifies e-mail messages as being protected when an e-mail message is received from a selected or trusted sender. In these examples, the identification occurs when a sender desires the protection for an e-mail message. The identification may be through some indicator or flag placed in the e-mail message from the sender. When an e-mail message is identified as protected, a selection of that e-mail message for deletion results in a prompt being presented to the user. The e-mail message then may be deleted through another user input. In some cases, the e-mail message may not be deleted even with an additional user input. Consequently, accidental or unintended deletion of e-mail messages may be avoided.

Further, an e-mail message may be identified as being protected a one or more or than merely a flag or indicator indicating the desirability of protection. For example, these identifiers may be the subject of the e-mail message, the sender, a combination of the two, or by some other combination of fields or text in the e-mail message. With a combination of identifiers, a sender may mark the e-mail message as protected using an indicator, but the e-mail message will be protected only if another identifier is present, such as a particular subject. In another example, a particular sender and subject may be required to protect the message.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a plurality of received e-mail messages, the method comprising:
identifying a set of e-mail messages from specified senders in the plurality of received e-mail messages in which the set of e-mail messages are to be protected from deletion and form a set of protected e-mail messages;
responsive to a selection of a protected e-mail message from the set of protected e-mail messages for deletion, providing an indication that the protected e-mail message selected for deletion is protected; and
responsive to the selection of the protected e-mail message, prohibiting deletion of the protected e-mail message unless a further user input is received.

2. The method of claim 1 further comprising:
receiving an identifier by at least one of a subject and a sender for identifying the set of e-mail messages to be protected from deletion.

3. The method of claim 1 further comprising:
assigning a pre-designated expiration date for the set of protected e-mail messages.

4. The method of claim 1 further comprising:
determining whether an indicator is present within a received e-mail message, wherein the indicator indicates that protection is desired for the received e-mail message; and
determining whether the received e-mail message is from one of the specified senders if the indicator is present in the received e-mail message, wherein the e-mail message is a protected e-mail message within the set of e-mail messages if the received e-mail is from one of the specified senders.

5. The method of claim 1, wherein the indicator is at least one of a graphical indicator associated with a display of the protected e-mail message in a mail box and a window containing a message identifying the protected e-mail message as being protected from deletion.

6. The method of claim 1 further comprising:
prohibiting deletion of the protected e-mail message even if the further user input is received if the protected e-mail message is from a selected specified sender.

7. The method of claim 1 further comprising:
removing e-mail messages from the set of protected e-mail messages after a selected period of time.

8. A data processing system for managing a plurality of received e-mail messages, the data processing system comprising:
identifying means for identifying a set of e-mail messages from specified senders in the plurality of received e-mail messages in which the set of e-mail messages are to be protected from deletion and form a set of protected e-mail messages;
providing means, responsive to a selection of a protected e-mail message from the set of protected e-mail messages for deletion, for providing an indication that the protected e-mail message selected for deletion is protected; and
prohibiting means, responsive to the selection of the protected e-mail message, for prohibiting deletion of the protected e-mail message unless a further user input is received.

9. The data processing system of claim 8 further comprising:
receiving means for receiving an identifier by at least one of a subject and a sender for identifying the set of e-mail messages to be protected from deletion.

10. The data processing system of claim 8 further comprising:
assigning means for assigning a pre-designated expiration date for the set of protected e-mail messages.

11. The data processing system of claim 8 further comprising:
first determining means for determining whether an indicator is present within a received e-mail message, wherein the indicator indicates that protection is desired for the received e-mail message; and
second determining means for determining whether the received e-mail message is from one of the specified senders if the indicator is present in the received e-mail message, wherein the e-mail message is a protected e-mail message within the set of e-mail messages if the received e-mail is from one of the specified senders.

12. The data processing system of claim 8, wherein the indicator is at least one of a graphical indicator associated with a display of the protected e-mail message in a mail box and a window containing a message identifying the protected e-mail message as being protected from deletion.

13. The data processing system of claim 8 further comprising:
prohibiting means for prohibiting deletion of the protected e-mail message even if the further user input is received if the protected e-mail message is from a selected specified sender.

14. The data processing system of claim 8 further comprising:
removing means for removing e-mail messages from the set of protected e-mail messages after a selected period of time.

15. A computer program product in a computer readable medium for managing a plurality of received e-mail messages, the computer program product comprising:
first instructions for identifying a set of e-mail messages from specified senders in the plurality of received e-mail messages in which the set of e-mail messages are to be protected from deletion and form a set of protected e-mail messages;
second instructions, responsive to a selection of a protected e-mail message from the set of protected e-mail messages for deletion, for providing an indication that the protected e-mail message selected for deletion is protected; and
third instructions, responsive to the selection of the protected e-mail message, for prohibiting deletion of the protected e-mail message unless a further user input is received.

16. The computer program product of claim 15 further comprising:
fourth instructions for receiving an indication by at least one of a subject and a sender for identifying the set of e-mail messages to be protected from deletion.

17. The computer program product of claim 15 further comprising:
fourth instructions for assigning a pre-designated expiration date for the set of protected e-mail messages.

18. The computer program product of claim 15 further comprising:
fourth instructions for determining whether an indicator is present within a received e-mail message, wherein the indicator indicates that protection is desired for the received e-mail message; and
fifth instructions for determining whether the received e-mail message is from one of the specified senders if the indicator is present in the received e-mail message, wherein the e-mail message is a protected e-mail message within the set of e-mail messages if the received e-mail is from one of the specified senders.

19. The computer program product of claim 15, wherein the indicator is at least one of a graphical indicator associated with a display of the protected e-mail message in a mail box and a window containing a message identifying the protected e-mail message as being protected from deletion.

20. The computer program product of claim 15 further comprising:
fourth instructions for prohibiting deletion of the protected e-mail message even if the further user input is received if the protected e-mail message is from a selected specified sender.
